(19) United States
(12) Patent Application Publication
(10) Pub. No.: US 2026/0302074 A1
(43) Pub. Date: Oct. 1, 2026

(54) MULTILAYER CERAMIC ELECTRONIC COMPONENT

(71) Applicant: Murata Manufacturing Co., Ltd., Nagaokakyo-shi (JP)

(72) Inventors: Kota ZENZAI, Nagaokakyo-shi (JP); Tatsunori YASUDA, Nagaokakyo-shi (JP)

(21) Appl. No.: 19/536,508

(22) Filed: Feb. 11, 2026

(30) Foreign Application Priority Data
Mar. 25, 2025 (JP) 2025-050602

(51) Int. Cl. H01G 4/30; H01G 4/224; H01G 4/232

(52) U.S. Cl. CPC H01G 4/30; H01G 4/224; H01G 4/2325

(57) ABSTRACT

A ceramic capacitor includes a capacitor body including a multilayer body including a main surface and a pair of outer electrodes separate from each other in a length direction, a pair of spacers each connected to a respective one of the pair of outer electrodes, and an insulating resin layer on the main surface. Each of the pair of spacers includes a core portion and a protrusion on the core portion to limit movement of the insulating resin layer. The insulating resin layer is directly connected to the main surface of the multilayer body and the protrusion.

### CROSS REFERENCE TO RELATED APPLICATIONS

This application claims the benefit of priority to Japanese Patent Application No. 2025-050602 filed on Mar. 25, 2025. The entire contents of this application are hereby incorporated herein by reference.

### BACKGROUND OF THE INVENTION

### 1. Field of the Invention

The present invention relates to multilayer ceramic electronic components.

### 2. Description of the Related Art

In recent years, a multilayer ceramic capacitor having a high capacitance and a small size has been desired. Such a multilayer ceramic capacitor includes an inner layer portion in which dielectric layers composed of a ferroelectric material having a comparatively high dielectric constant and inner electrodes are alternately laminated.

Further, dielectric layers as outer layer portions are provided on the upper and lower sides of the inner layer portion to form a multilayer body having a rectangular parallelepiped shape, and outer electrodes are provided on both end surfaces of the multilayer body in a longitudinal direction, thereby forming a capacitor body.

Moreover, there is known a multilayer ceramic capacitor including a spacer on a side of mounting on a substrate in the capacitor body for suppressing the occurrence of so-called “acoustic noise” (refer to International Publication No. WO/2015/098990).

### SUMMARY OF THE INVENTION

However, when an adhesion force between the capacitor body and the spacer is weak, the spacer is sometimes peeled off, and thus durability when the multilayer ceramic capacitor is mounted has not been sufficient.

Example embodiments of the present invention provide multilayer ceramic electronic components that each achieve a high adhesion force between a capacitor body and a spacer and is excellent in durability when mounted.

A multilayer ceramic electronic component according to an example embodiment of the present invention includes a capacitor body including a multilayer body including a main surface and a pair of outer electrodes provided separately from each other in a first direction, a pair of spacers each connected to a respective one of the pair of outer electrodes, and a coating material on the main surface, wherein each of the pair of spacers includes a main portion and a protrusion that is on the main portion to limit movement of the coating material, and the coating material is directly connected to the main surface of the multilayer body and the protrusion.

According to example embodiments of the present invention, it is possible to provide multilayer ceramic electronic components that each achieve a high adhesion force between the capacitor body and the spacer and is excellent in durability when mounted.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to a first example embodiment of the present invention.

FIG. 2 is a partial cross-sectional view of the multilayer ceramic capacitor taken along line II-II in FIG. 1.

FIG. 3 is a cross-sectional view of the multilayer ceramic capacitor taken along line III-III in FIG. 1.

FIG. 4 is a partially enlarged view of FIG. 2 and is a cross-sectional view depicting a connection state of a spacer and an insulating resin layer.

FIG. 5 is a flowchart for explaining a manufacturing method for the multilayer ceramic capacitor.

FIGS. 6A to 6D are diagrams for explaining a multilayer body manufacturing step and an outer electrode forming step.

FIGS. 7A to 7C are diagrams for explaining a spacer disposing step and an insulating resin layer forming step.

FIG. 8 is a cross-sectional view depicting a connection state of a spacer and an insulating resin layer in a second example embodiment of the present invention.

FIG. 9 is a cross-sectional view depicting a connection state of a spacer and an insulating resin layer in a third example embodiment of the present invention.

FIG. 10 is a schematic diagram depicting a positional relationship and a dimensional relationship among a multilayer body second main surface of a multilayer body, a first spacer and a second spacer, and a first protrusion and a second protrusion in a modification of the first example embodiment of the present invention.

### DETAILED DESCRIPTION OF THE EXAMPLE EMBODIMENTS

Multilayer ceramic capacitors according to example embodiments of multilayer ceramic electronic components of the present invention are described below. However, the present invention is not limited thereto. Further, in some cases, the drawings are schematically depicted in a simplified manner for describing the content of the invention, and the ratio of dimensions in a depicted component or between depicted components does not coincide with the ratio of these dimensions described in the specification. In addition, there are a case in which a component described in the specification is omitted in the drawing, a case in which a component described in the specification is depicted with a reduced number of components for simplification, and the like.

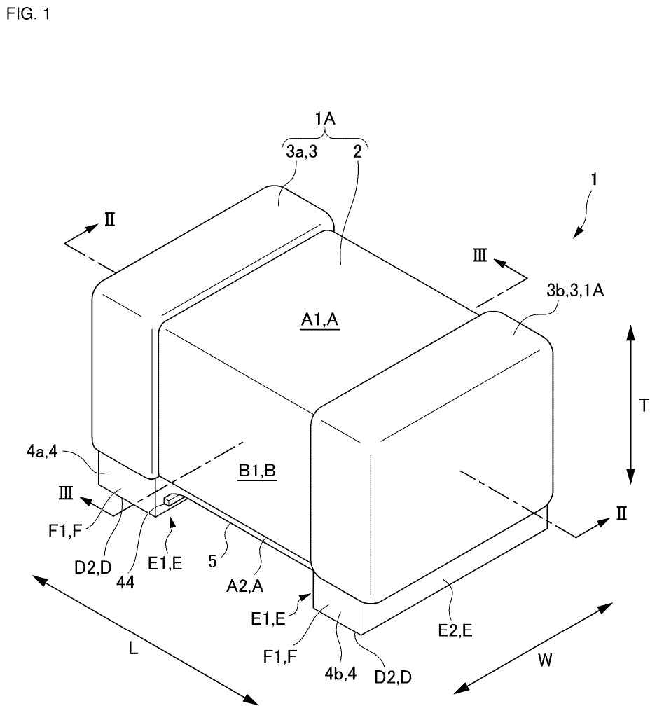

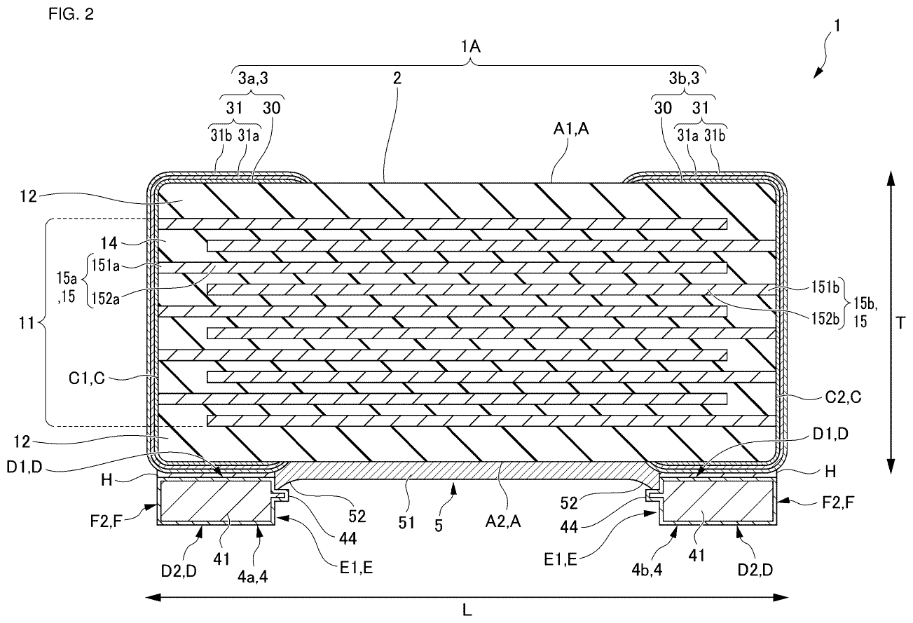

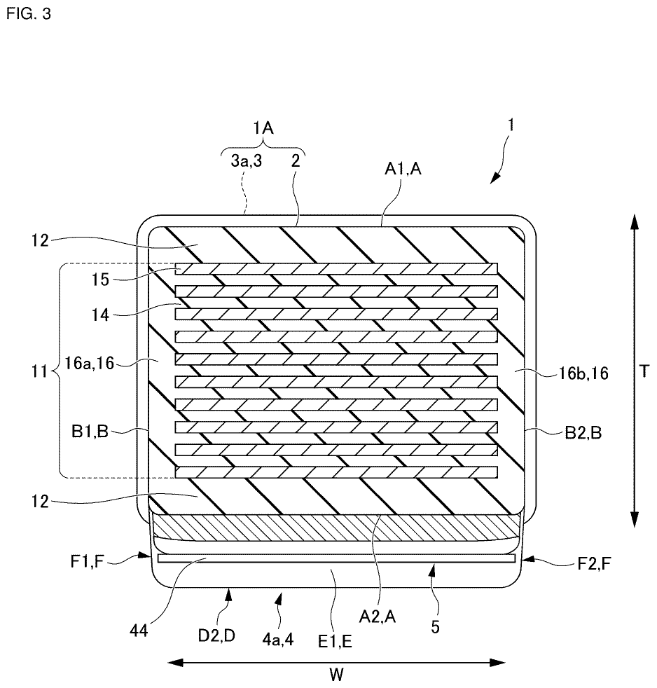

A first example embodiment of the present invention is described below. FIG. 1 is a schematic perspective view of the multilayer ceramic capacitor 1 according to the first example embodiment. FIG. 2 is a partial cross-sectional view of the multilayer ceramic capacitor 1 taken along line II-II in FIG. 1. FIG. 3 is a cross-sectional view of the multilayer ceramic capacitor 1 taken along line III-III in FIG. 1. Line II-II passes through the center of the multilayer ceramic capacitor 1 in a width direction W to be described later, and line III-III passes through the center in a length direction L to be described later.

The multilayer ceramic capacitor 1 includes a capacitor body 1A that has a substantially rectangular parallelepiped shape and includes a multilayer body 2 and a pair of outer electrodes 3 at both ends of the multilayer body 2, spacers 4 attached to the capacitor body 1A, and an insulating resin layer 5 (coating material). Further, the multilayer body 2 includes an inner layer portion 11 including a plurality of sets of dielectric layers 14 and inner electrode layers 15.

In the following description, as a term representing an orientation of the multilayer ceramic capacitor 1, a direction in which the pair of outer electrodes 3 are opposed to each other is defined as the length direction L (first direction). A direction in which the dielectric layers 14 and the inner electrode layers 15 are laminated is defined as a lamination direction T (height direction). A direction intersecting both the length direction L and the lamination direction T is defined as the width direction W (second direction). In the present example embodiment, the width direction W is orthogonal to both the length direction L and the lamination direction T.

Among six outer surfaces of the multilayer body 2, a pair of outer surfaces facing each other in the lamination direction T are defined as a multilayer body first main surface A1 and a multilayer body second main surface A2. Further, a pair of outer surfaces facing each other in the width direction W are defined as a multilayer body first side surface B1 and a multilayer body second side surface B2. In addition, a pair of outer surfaces facing each other in the length direction L are defined as a multilayer body first end surface C1 and a multilayer body second end surface C2.

When it is not required to particularly distinguish between the multilayer body first main surface A1 and the multilayer body second main surface A2, they are collectively referred to as multilayer body main surfaces A. When it is not required to particularly distinguish between the multilayer body first side surface B1 and the multilayer body second side surface B2, they are collectively referred to as multilayer body side surfaces B. When it is not required to particularly distinguish between the multilayer body first end surface C1 and the multilayer body second end surface C2, they are collectively referred to as multilayer body end surfaces C.

The spacers 4 are a pair of structures (described later). Among six outer surfaces of the spacer 4, of a pair of outer surfaces facing each other in the lamination direction T, an outer surface on the capacitor body 1A side is defined as a spacer first main surface D1 (first main surface), and an outer surface on the opposite side thereof is defined as a spacer second main surface D2 (second main surface). The spacer first main surface D1 is a surface on the multilayer body 2 side, and the spacer second main surface D2 is a surface on the mounting substrate (not depicted) side.

Of a pair of outer surfaces of the spacer 4 facing each other in the length direction L, a surface on the side where the two spacers 4 are opposed to each other is defined as a spacer first end surface E1 (inner surface), and an outer surface on the opposite side thereof is defined as a spacer second end surface E2.

Of a pair of outer surfaces of the spacer 4 facing each other in the width direction W, a surface on a single side in the width direction W is defined as a spacer first side surface F1 (first side surface), and a surface on the opposite side is defined as a spacer second side surface F2 (second side surface).

When it is not required to particularly distinguish between the spacer first main surface D1 and the spacer second main surface D2, they are collectively referred to as spacer main surfaces D. When it is not required to particularly distinguish between the spacer first end surface E1 and the spacer second end surface E2, they are collectively referred to as spacer end surfaces E. When it is not required to particularly distinguish between the spacer first side surface F1 and the spacer second side surface F2, they are collectively referred to as spacer side surfaces F.

The dimensions of the multilayer body 2 are not particularly limited. However, it is preferable that the dimensions be as follows: a dimension in the length direction L is about 1.0 mm or more and about 3.2 mm or less, a dimension in the width direction W is about 0.5 mm or more and about 1.6 mm or less, and a dimension in the lamination direction T is about 0.5 mm or more and about 1.6 mm or less, for example.

The multilayer body 2 includes the inner layer portion 11, outer layer portions 12 on both sides of the inner layer portion 11 in the lamination direction T, and side gap portions 16 on both sides of the inner layer portion 11 and the outer layer portions 12 in the width direction W.

The inner layer portion 11 includes the plurality of sets of the dielectric layers 14 and the inner electrode layers 15 alternately laminated along the lamination direction T.

It is preferable that the thickness of the dielectric layer 14 be about 0.5 μm or less, for example. The dielectric layer 14 is made of a ceramic material. As the ceramic material, for example, a dielectric ceramic including BaTiO₃ as a main component is used. In addition, as the ceramic material, a material obtained by adding at least one of subcomponents such as a Mn compound, an Fe compound, a Cr compound, a Co compound, or a Ni compound to the main component may be used. It is preferable that the number of dielectric layers 14, including those of the outer layer portions 12, be 15 or more and 700 or less, for example.

Further, the inner electrode layers 15 include a plurality of first inner electrode layers 15a and a plurality of second inner electrode layers 15b. The first inner electrode layers 15a and the second inner electrode layers 15b are alternately provided. When it is not required to particularly distinguish between the first inner electrode layers 15a and the second inner electrode layers 15b, they are collectively referred to as the inner electrode layers 15.

The first inner electrode layers 15a each include a first opposing portion 152a opposed to the second inner electrode layer 15b and a first extended portion 151a extended from the first opposing portion 152a toward the multilayer body first end surface C1 side. End portions of the first extended portions 151a are exposed at the multilayer body first end surface C1, and are electrically connected to a first outer electrode 3a to be described later.

The second inner electrode layers 15b each include a second opposing portion 152b opposed to the first inner electrode layer 15a and a second extended portion 151b extended from the second opposing portion 152b to the multilayer body second end surface C2. End portions of the second extended portions 151b are electrically connected to a second outer electrode 3b to be described later.

A charge is accumulated in the first opposing portions 152a of the first inner electrode layers 15a and the second opposing portions 152b of the second inner electrode layers 15b, and characteristics of the capacitor are exhibited.

As described above, the end portions of the first extended portions 151a of the first inner electrode layers 15a are exposed at the multilayer body first end surface C1, and are electrically connected to the first outer electrode 3a. Further, the end portions of the second extended portions 151b of the second inner electrode layers 15b are exposed at the multilayer body second end surface C2, and are electrically connected to the second outer electrode 3b. This provides a structure in which a plurality of capacitor elements are electrically connected in parallel between the first outer electrode 3a and the second outer electrode 3b.

It is preferable that the inner electrode layer 15 be formed of a metal material typified by, for example, Ni, Cu, Ag, Pd, an Ag—Pd alloy, Au, or the like. It is preferable that the thickness of the inner electrode layer 15 be, for example, about 0.5 μm or more and about 2.0 mm or less, for example. It is preferable that the total number of the inner electrode layers 15, including the first inner electrode layers 15a and the second inner electrode layers 15b, be 15 or more and 700 or less, for example. Further, a Sn layer may be present at an interface between the inner electrode layer 15 and the dielectric layer 14.

The shape of the first opposing portion 152a of the first inner electrode layer 15a and the shape of the second opposing portion 152b of the second inner electrode layer 15b are not particularly limited, but are preferably rectangular in plan view. However, a corner portion may be rounded in plan view, or the corner portion may be oblique in plan view. Further, the shape may be a tapered shape in which an inclination is given in a direction toward either end portion in plan view.

The shape of the first extended portion 151a of the first inner electrode layer 15a and the shape of the second extended portion 151b of the second inner electrode layer 15b are not particularly limited, but are preferably rectangular in plan view. However, a corner portion may be rounded in plan view, or the corner portion may be oblique in plan view (tapered shape). Further, the shape may be a tapered shape in which an inclination is given in a direction toward either end portion in plan view.

It is preferable that the outer layer portion 12 be made of the same material as that of the dielectric layer 14 of the inner layer portion 11, but the material is not particularly limited. The amount of an additive may be different between the inner layer portion 11 and the outer layer portion 12. Further, the thickness of the outer layer portion 12 in the lamination direction T is, for example, about 20 μm or less, and is preferably about 10 μm or less.

The side gap portions 16 are provided on both sides of the inner layer portion 11 and the outer layer portions 12 in the width direction W, and include a first side gap portion 16a forming the multilayer body first side surface B1 of the multilayer ceramic capacitor 1 and a second side gap portion 16b of the multilayer body second side surface B2 of the multilayer ceramic capacitor 1. The side gap portion 16 can be formed of the same material as that of the dielectric layer 14. When the side gap portions 16 are additionally provided on both sides of the inner layer portion 11 and the outer layer portions 12 in the width direction W, it is possible to reduce the amount of positional deviation of the end portions of the inner electrode layers 15 in the width direction W. The amount of positional deviation of the end portions of the inner electrode layers 15 in the width direction W is preferably about 5 μm or less, and more preferably about 0.5 μm or less, for example. The amount of an additive may be different between the inner layer portion 11 and the side gap portion 16. The amount of an additive may be different between the outer layer portion 12 and the side gap portion 16.

The outer electrodes 3 are provided on the multilayer body end surfaces C on both sides of the multilayer body 2. The outer electrodes 3 cover not only the multilayer body end surfaces C but also portions of the multilayer body main surfaces A and the multilayer body side surfaces B on the multilayer body end surface C side. As described above, the end portions of the extended portions 151 of the inner electrode layers 15 are exposed at the multilayer body end surfaces C, and are electrically connected to the outer electrodes 3. Specifically, the outer electrodes 3 include the first outer electrode 3a on the multilayer body first end surface C1 and the second outer electrode 3b on the multilayer body second end surface C2. When it is not required to particularly distinguish between the first outer electrode 3a and the second outer electrode 3b, they are collectively referred to as the outer electrodes 3.

The outer electrodes 3 each include an underlying electrode layer 30 and a plated layer 31.

The underlying electrode layer 30 is formed, for example, by applying and baking a conductive paste including copper (Cu). The underlying electrode layer 30 may include a glass component or a ceramic material. As depicted in FIG. 2, the underlying electrode layers 30 extend not only on the multilayer body end surfaces C on both sides of the multilayer body 2 but also to the multilayer body main surface A side to cover also portions of the multilayer body main surfaces A on the multilayer body end surface C side.

The plated layer 31 includes a Ni plated layer 31a on a surface of the underlying electrode layer 30 and a Sn plated layer 31b on a surface of the Ni plated layer 31a. The Ni plated layer 31a includes plating of Ni or an alloy including Ni. Similarly to the underlying electrode layers 30, the Ni plated layers 31a extend not only on the multilayer body end surfaces C on both sides of the multilayer body 2 but also to the multilayer body main surface A side to cover also portions of the multilayer body main surfaces A on the multilayer body end surface C side. The Sn plated layer 31b is located on the surface of the Ni plated layer 31a. The Sn plated layer 31b includes plating of Sn or an alloy including Sn. Although the Ni plated layer 31a and the Sn plated layer 31b have been given as examples of the plated layer 31, the plated layer 31 is not limited thereto.

The spacers 4 are a pair of structures as described above, and, specifically, include a first spacer 4a and a second spacer 4b. Hereinafter, when it is not required to distinguish between the first spacer 4a and the second spacer 4b, they are referred to as the spacers 4.

The first spacer 4a is located on the multilayer body first end surface C1 side on one side in the length direction L under the multilayer body second main surface A2 of the capacitor body 1A, and the second spacer 4b is located on the multilayer body second end surface C2 side on the other side. The first spacer 4a and the second spacer 4b are opposed to each other, and are spaced by a certain distance.

The spacers 4 are electrically connected to the outer electrodes 3 by solder H (conductive adhesive). Specifically, the spacer first main surfaces D1, which are upper surfaces of the spacers 4, are joined to the outer electrodes 3 with the solder H under the multilayer body second main surface A2, which is a lower surface of the capacitor body 1A. The solder H includes a metal having a melting point of about 210° C. or higher as a main component, for example. In the present example embodiment, the solder H is manufactured using, for example, high-temperature solder. The high-temperature solder is a metal that includes, for example, Sn, Ag, or Cu and has a remelting temperature of about 300° C. or higher. After being once melted at about 200° C. or higher and then cooled and solidified, the high-temperature solder is not remelted unless heated to about 300° C. or higher, for example. The solder H is not limited thereto. For example, Sn-Sb-based high-temperature solder may be used. When the spacers 4 and the outer electrodes 3 are connected using the solder H, if Sn plated layers are used as the outermost surfaces of the outer electrodes 3 and the spacers 4, part of the Sn plated layers is absorbed into the solder H and a boundary therebetween becomes unclear in some cases. The conductive adhesive is not limited to the solder H, and a substance obtained by combining a thermosetting resin and metal powder may be used as the conductive adhesive.

The spacer 4 includes a core portion 41 (main portion). The core portion 41 includes a metal block body including a metallic component as a main component or a substrate such as flame retardant type 4 FR4). As an example, the core portion 41 includes at least one high-melting-point metal selected from Cu and Ni. That is, the melting point of the core portion 41 is higher than the melting point of solder (conductive adhesive) used in mounting and the melting point of the solder H (conductive adhesive) used in connecting the spacers 4 and the outer electrodes 3. When the core portion includes a substrate, it is preferable to use a porous substrate because stress can be buffered. When the core portion 41 includes a bulk body including a metal block body, a substrate, or the like, compared with a case in which the spacer 4 includes a metal paste including an organic component and a metallic component, the existence ratio of voids interposed inside can be reduced or be made zero, or sizes of the voids can be reduced. Thus, it is possible to reduce a possibility that the spacer 4 itself fractures.

The spacer 4 includes a protrusion 44 that is provided on the core portion 41 to limit movement of a material of the insulating resin layer 5. The protrusion 44 is provided on the spacer first end surface E1 of the core portion 41.

Specifically, the protrusion 44 protrudes on the spacer first end surface E1 of the core portion 41 toward the other spacer in the length direction L, and has a predetermined length in the width direction W. As depicted in FIG. 3, both ends of the protrusion 44 in the width direction W are close to both ends of the spacer first end surface E1 in the width direction W. Both ends of the protrusion 44 in the width direction W may extend to both ends of the spacer first end surface E1 in the width direction W.

The distance between the spacer first end surface E1 of the first spacer 4a and a center of the multilayer body 2 in the length direction L and the distance between the spacer first end surface E1 of the second spacer 4b and the center of the multilayer body 2 in the length direction L are the same or substantially the same. The projection length of the protrusion 44 of the first spacer 4a in the length direction L and the projection length of the protrusion 44 of the second spacer 4b in the length direction L are the same or substantially the same. The tip of the protrusion 44 in the length direction L may be located closer to the center in the length direction L than a tip of the underlying electrode layer 30 in the length direction L, and may be located closer to the center in the length direction L than a tip of the plated layer 31 in the length direction L. This can increase the connection area with the solder H (conductive adhesive) used in joining the spacer 4 and the outer electrode 3.

More specifically, the protrusion 44 includes a first main surface 44a facing toward the multilayer body 2 in the lamination direction T, a side surface 44b facing toward the other spacer 4 in the length direction L, and a second main surface 44c facing toward the side opposite to the multilayer body 2 in the lamination direction T.

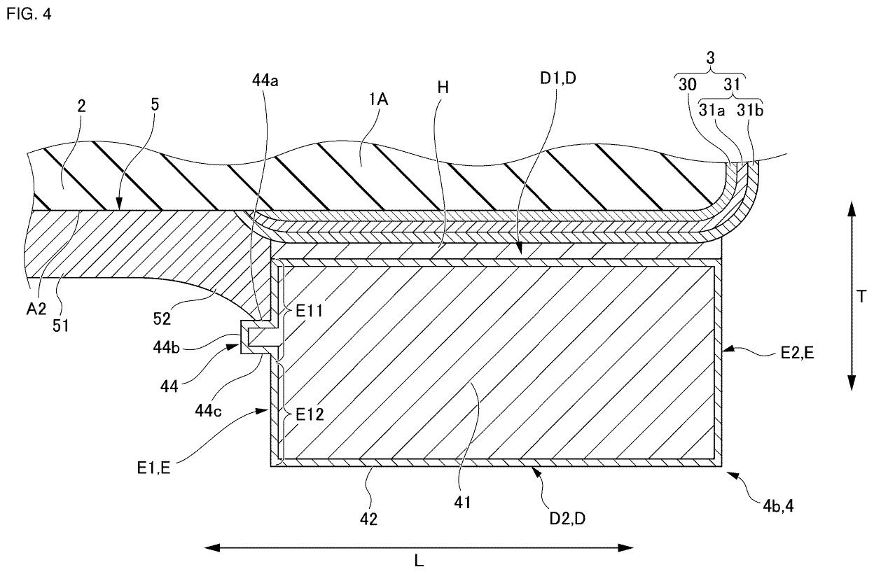

As depicted in FIG. 4, the spacer 4 includes a low-melting-point surface layer 42. The low-melting-point surface layer 42 includes, for example, Sn. It is preferable that the low-melting-point surface layer 42 have favorable wettability with the solder H (conductive adhesive) used in mounting and for connecting the spacer 4 and the outer electrode 3. With the low-melting-point surface layer 42, favorable solderability is achieved at the spacer 4 when the multilayer ceramic capacitor 1 is mounted on a substrate.

The low-melting-point surface layer 42 entirely coats the core portion 41. Specifically, the low-melting-point surface layer 42 is provided on the spacer main surfaces D, the spacer side surfaces F, and the spacer end surfaces E of the core portion 41.

The low-melting-point surface layer 42 covers the entire surface of the protrusion 44. As a modification, it is also possible that the low-melting-point surface layer 42 does not cover a portion of the protrusion 44 or does not cover the protrusion 44 at all.

As depicted in FIG. 1, the insulating resin layer 5 is between the two spacers 4 so as to cover the multilayer body second main surface A2 side of the capacitor body 1A. The spacers 4 are physically connected to the multilayer body 2 by the insulating resin layer 5 (described later).

The insulating resin layer 5 includes an insulating resin. A surface of the insulating resin may be coated with a water-repellent treatment agent. Flexural strength is improved by forming the insulating resin layer 5 from the insulating resin. Further, moisture resistance is improved by coating the insulating resin with the water-repellent treatment agent. The insulating resin may include a ceramic, glass, or the like. The insulating resin layer 5 includes an epoxy resin as a main component, and a phenolic resin can be combined therewith as a curing agent. When a viscous material such as an epoxy resin is used, the multilayer body 2 and the spacers 4 can be connected more easily. As other curing agents, acid anhydride-based, amine-based, and ester-based curing agents, and the like, can be used. A curing accelerator may further be added to the epoxy resin. The insulating resin layer 5 may include only the water-repellent treatment agent.

As depicted in FIG. 2, the insulating resin layer 5 is provided continuously in the length direction L between the spacer first end surface E1 of one of the spacers 4 and the spacer first end surface E1 of the other spacer 4, and covers the multilayer body second main surface A2 side of the capacitor body 1A (multilayer body 2) and the spacer first end surfaces E1 of the two spacers 4.

However, the insulating resin layer 5 is not necessarily required to be continuous between the first spacer 4a and the second spacer 4b. The insulating resin layer 5 may be discontinuously provided in such a manner as to be divided, for example, into a layer coating the spacer first end surface E1 of the first spacer 4a and a portion of the multilayer body second main surface A2 side of the capacitor body 1A (multilayer body 2) and a layer coating the spacer first end surface E1 of the second spacer 4b and part of the multilayer body second main surface A2 side of the capacitor body 1A (multilayer body 2).

A connection state of the spacer 4 and the insulating resin layer 5 is described with reference to FIG. 4. FIG. 4 is a partially enlarged view of FIG. 2 and is a cross-sectional view depicting the connection state of the spacer 4 and the insulating resin layer 5.

The insulating resin layer 5 is directly connected to the multilayer body second main surface A2 of the multilayer body 2 and the protrusion 44 of the spacer 4. The insulating resin layer 5 is also connected to the solder H (conductive adhesive). Specifically, the insulating resin layer 5 includes a main layer 51 on the multilayer body second main surface A2 and connection portions 52 at both ends of the main layer 51, and the connection portions 52 are each connected to the protrusion 44 and the solder H (conductive adhesive). The connection portions 52 are upward-spread portions extending from the main layer 51.

Specifically, the connection portion 52 of the insulating resin layer 5 is connected to a portion of the spacer first end surface E1 of the core portion 41 on the multilayer body 2 side and the first main surface 44a of the protrusion 44. As a modification, the connection portion 52 may be connected to the side surface 44b in addition to the first main surface 44a. As another modification, the connection portion 52 may be connected to the second main surface 44c in addition to the first main surface 44a and the side surface 44b. As still another modification, the connection portion 52 may be connected also to a portion of the spacer first end surface E1 of the core portion 41 on the side opposite to the multilayer body 2 across the protrusion 44.

In the present example embodiment, in the core portion 41, a bulk body including a metal block body, a substrate, or the like and a thin film on a surface of the bulk body by, for example, plating or the like are provided. When the roughness of the surface of the core portion 41 becomes small, there is a possibility that the material of the insulating resin layer 5 excessively spreads upward to the spacer second main surface D2 and a dimensional difference from the first spacer 4a and the second spacer 4b in the lamination direction T increases and mounting becomes unstable. Further, there is a possibility that the material of the insulating resin layer 5 excessively extends around to the spacer second end surface E2 and thus the solder H (conductive adhesive) used in mounting does not sufficiently adhere to the spacer 4.

As described above, in the present example embodiment, the protrusion 44 is provided on the spacer first end surface E1 of the spacer 4, and the insulating resin layer 5 and the protrusion 44 are directly connected to each other. That is, excessive upward spreading of the material of the insulating resin layer 5 can be prevented or reduced by the protrusion 44. Further, the protrusion 44 can increase the adhesion area between the insulating resin layer 5 and the spacer 4.

The protrusion 44 may be provided on a portion of a first region E11 on the multilayer body 2 side, of regions obtained by bisecting the spacer first end surface E1 in the lamination direction T of the spacer 4. That is, the protrusion 44 is not required to be provided in a second region E12 on the side opposite to the multilayer body 2, of the regions obtained by bisecting the spacer first end surface E1 in the lamination direction T of the spacer 4. Thus, it is possible to properly limit the amount of movement of the material of the insulating resin layer 5.

The surface roughness of the protrusion 44 is rougher than that of the core portion 41. As a result, due to an anchor effect, the adhesion strength between the insulating resin layer 5 and the protrusion 44 can be increased. Roughening treatment for the protrusion 44 may be performed by chemical etching or the like, or by applying a physical impact. The surface roughness of the side surface 44b of the protrusion 44 may be rougher than the surface roughness of the first main surface 44a of the protrusion 44, and may be rougher than the surface roughness of the second main surface 44c of the protrusion 44.

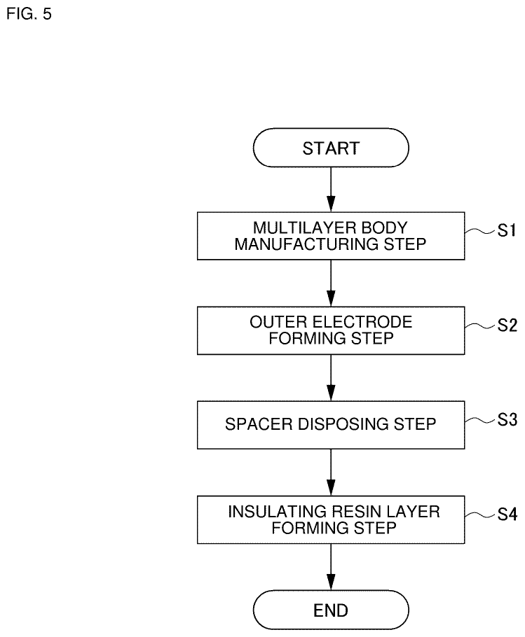

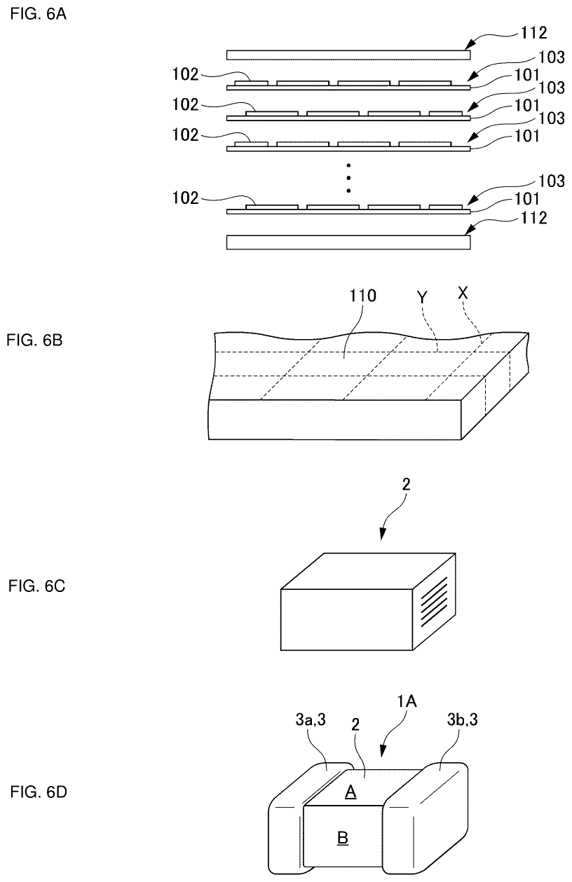

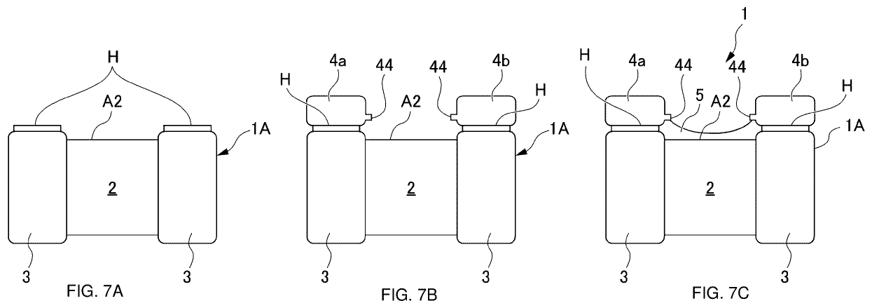

A non-limiting example of a manufacturing method for the multilayer ceramic capacitor 1 is described with reference to FIGS. 5 to 7. FIG. 5 is a flowchart for explaining the manufacturing method for the multilayer ceramic capacitor. FIG. 6 is a diagram for explaining a multilayer body manufacturing step and an outer electrode forming step. FIG. 7 is a diagram for explaining a spacer disposing step and an insulating resin layer forming step.

As depicted in FIG. 5, the manufacturing method for the multilayer ceramic capacitor 1 includes a multilayer body manufacturing step S1, an outer electrode forming step S2, a spacer disposing step S3, and an insulating resin layer forming step S4.

Ceramic slurry including ceramic powder, a binder, and a solvent is formed in a sheet shape on a surface of a carrier film using a die coater, a gravure coater, a micro-gravure coater, or the like to fabricate a ceramic green sheet 101 for lamination to serve as the dielectric layer 14. Next, a conductor paste is printed in a strip shape on the ceramic green sheet 101 for lamination by screen printing, ink-jet printing, gravure printing, or the like to print a conductive pattern 102 to serve as the inner electrode layer 15 on a surface of the ceramic green sheet 101 for lamination, thereby fabricating a material sheet 103.

Subsequently, as depicted in FIG. 6A, a plurality of material sheets 103 are stacked such that the conductive patterns 102 are oriented in the same direction and, between adjacent material sheets 103, the conductive patterns 102 are offset from each other in the length direction L by, for example, a half pitch. Further, ceramic green sheets 112 for the outer layer portion to serve as the outer layer portions 12 are stacked on both sides of the plurality of stacked material sheets 103.

The stacked material sheets 103 and the ceramic green sheets 112 for the outer layer portion are pressure-bonded by isostatic pressing or the like to fabricate a mother block 110 depicted in FIG. 6B.

Next, the mother block 110 is cut along cutting lines X depicted in FIG. 6B and cutting lines Y intersecting the cutting lines X to manufacture a plurality of multilayer bodies 2 depicted in FIG. 6C.

Subsequently, the underlying electrode layers 30 are formed by applying a conductive paste including copper (Cu) to the multilayer body end surfaces C of the multilayer body 2 and baking the conductive paste. The underlying electrode layers 30 are formed so as to extend not only on the multilayer body end surfaces C on both sides of the multilayer body 2 but also to the multilayer body main surface A side and the multilayer body side surface B side of the multilayer body 2 to cover also parts of the multilayer body main surfaces A on the multilayer body end surface C side. Next, the Ni plated layers 31a and the Sn plated layers 31b on surfaces of the Ni plated layers 31a are formed as the plated layer 31 over surfaces of the underlying electrode layers 30, thereby manufacturing the capacitor body 1A depicted in FIG. 6D.

When the core portion 41 is formed of a metal block body including a metal as a main component, a metal plate having a predetermined thickness is first prepared. Thereafter, the metal plate is diced into a plate having a predetermined size, and then a surface layer is formed on a surface of the metal plate. The dicing of the metal plate may be performed, for example, so as to form a plate having a dimension close to the dimension of one multilayer ceramic capacitor in the length direction L, or having a dimension close to the total dimension of two multilayer ceramic capacitors in the width direction W, or having a dimension close to the total dimension of two outer electrodes provided in one multilayer ceramic capacitor in the length direction L. It is preferable that the surface layer be formed by plating. The surface layer may be formed before the above dicing, or may be formed after the above dicing. The surface layer may include two or more layers. Finally, plating for forming the low-melting-point surface layer 42 is performed to form the low-melting-point surface layer 42.

When the core portion 41 is formed of a substrate such as FR4, a substrate having a predetermined thickness is first prepared. Thereafter, the substrate is diced into a substrate having a predetermined size, and then a surface layer is formed on a surface of the substrate. The dicing of the substrate may be performed, for example, so as to form a substrate having a dimension close to the dimension of one multilayer ceramic capacitor in the length direction L, or having a dimension close to the total dimension of two multilayer ceramic capacitors in the width direction W, or having a dimension close to the total dimension of two outer electrodes in one multilayer ceramic capacitor in the length direction L. It is preferable that the surface layer be formed of, for example, a thin film of copper or the like and a plated layer. The surface layer may be formed before the above dicing, or may be formed after the above dicing. The surface layer may include two or more layers. Finally, plating for forming the low-melting-point surface layer 42 is performed to form the low-melting-point surface layer 42.

At this time, the protrusion 44 is formed at any position by forming the core portion 41 of the spacer 4 in a shape that partially protrudes and thereafter partially removing the core portion 41 by a laser or the like.

First, as depicted in FIG. 7A, the solder H in a cream state is provided on the capacitor body 1A by screen printing or the like. Next, as depicted in FIG. 7B, the first spacer 4a and the second spacer 4b are placed over the capacitor body 1A. Specifically, the first spacer 4a and the second spacer 4b are joined to the first outer electrode 3a and the second outer electrode 3b, respectively, of the capacitor body 1A. As another example, the following process may be used. A plate resulting from dicing is diced into a plate having a dimension close to the dimension of one multilayer ceramic capacitor in the length direction L, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is provided on the first spacer 4a and the second spacer 4b by screen printing or the like, and then the capacitor body 1A is placed thereon. Thereafter, reflow is performed to join the first spacer 4a and the second spacer 4b to the capacitor body 1A.

Alternatively, as another example, the following process may be used. A plate resulting from dicing is diced into a plate having a dimension close to the total dimension of two multilayer ceramic capacitors in the width direction W, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is provided on the first spacer 4a and the second spacer 4b by screen printing or the like, and then the capacitor body 1A is placed thereon. Thereafter, reflow is performed to join the first spacer 4a and the second spacer 4b to the capacitor body 1A. By joining the capacitor bodies 1A to the plate before forming the first spacer 4a and the second spacer 4b, and performing dicing between the capacitor bodies 1A arranged in the width direction W, the multilayer ceramic capacitors including the first spacer 4a and the second spacer 4b may be formed. In this case, the plate before forming the first spacer 4a and the second spacer 4b has a size larger than the total dimension of two multilayer ceramic capacitors in the width direction W. Further, the dimension of the first spacer 4a and the second spacer 4b in the width direction W may be larger than the dimension of the capacitor body 1A.

Alternatively, as another example, the following process may be used. A plate resulting from dicing is diced into a plate having a dimension close to the total dimension of two outer electrodes in one multilayer ceramic capacitor in the length direction L, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is provided on the first spacer 4a and the second spacer 4b by screen printing or the like, and then the capacitor body 1A is placed thereon. Thereafter, reflow is performed to join the first spacer 4a and the second spacer 4b to the capacitor body 1A. By joining the capacitor bodies 1A to the plate before forming the first spacer 4a and the second spacer 4b, and performing dicing between the capacitor bodies 1A arranged in the length direction L, the multilayer ceramic capacitors including the first spacer 4a and the second spacer 4b may be formed. In this case, the plate before forming the first spacer 4a and the second spacer 4b has a size larger than the total dimension of two outer electrodes in one multilayer ceramic capacitor in the length direction L. Further, a portion of the first spacer 4a and the second spacer 4b may protrude from the capacitor body 1A when viewed in the lamination direction T.

Next, as depicted in FIG. 7C, a resin material layer that becomes the insulating resin layer 5 is formed on the multilayer body second main surface A2 portion of the capacitor body 1A by using a dispenser or squeegee printing. At this time, the amount of upward spreading to the spacer can be varied depending on the amount and viscosity of the insulating resin.

By putting the capacitor body 1A to which the resin material layer has been applied in an environment at, for example, about 180° C. for about 60 minutes, the resin material layer is thermally cured. Although a thermosetting resin is used as the resin material layer in the present example embodiment, the resin material layer is not limited thereto and a photocurable resin may be used.

As a result, the resin material layer becomes the insulating resin layer 5 cured, and finally, the multilayer ceramic capacitor 1 is obtained. Between the spacer disposing step S3 and the insulating resin layer forming step S4, a protrusion roughening treatment step or a plating removal step may be provided.

As described above, according to the multilayer ceramic capacitor 1 of the present example embodiment, because the spacers 4 are attached to the capacitor body 1A, excessive upward spreading of solder used in mounting to the capacitor body 1A can be reduced or prevented by the spacers 4, and vibration transmitted to the mounting substrate can be reduced or prevented.

Further, according to the multilayer ceramic capacitor 1 of the present example embodiment, the insulating resin layer 5 is attached between the spacers 4. Accordingly, the adhesion force between the capacitor body 1A and the spacers 4 can be increased, and separation of the spacers 4 from the capacitor body 1A can be prevented. In addition, resistance to the occurrence of a crack or the like in the multilayer ceramic capacitor 1 when bending or the like occurs in the mounting substrate, that is, substrate bending resistance, is improved.

In the present example embodiment, the insulating resin layer 5 and the protrusion 44 are directly connected. That is, the protrusion 44 reduces the amount of movement of upward spreading of the insulating resin layer 5. That is, excessive upward spreading of the material of the insulating resin layer 5 attempting to move from the multilayer body second main surface A2 toward the spacer second main surface D2 of the spacer 4 can be blocked by the protrusion 44. Thus, it is possible to prevent excessive presence of the insulating resin layer 5 on the spacer second main surface D2, and to reduce or prevent a decrease in mountability caused by an increase in a dimensional difference from the first spacer 4a and the second spacer 4b in the lamination direction T. In addition, the adhesion area between solder in mounting and the spacer 4 can be sufficiently secured. As a result, the multilayer ceramic capacitor 1 excellent in durability when mounted is achieved.

In the first example embodiment, the protrusion 44 is provided on the spacer first end surface E1, which is the inner surface of the spacer 4. However, the position at which the protrusion 44 is located is not limited to the spacer first end surface E1 of the spacer 4.

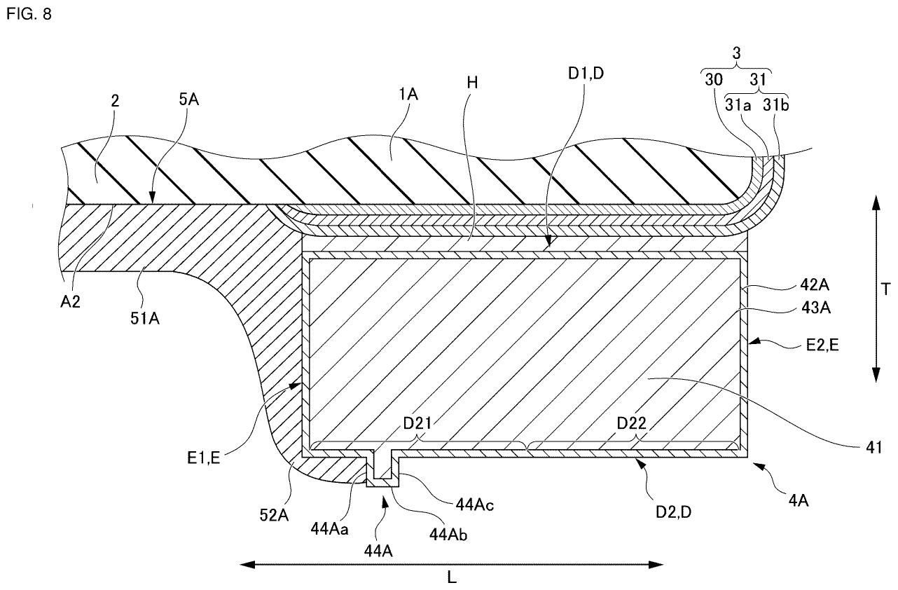

With reference to FIG. 8, a second example embodiment is described as an example in which the position at which the protrusion 44 is located is different from that of the first example embodiment. FIG. 8 is a cross-sectional view depicting a connection state of a spacer 4A and an insulating resin layer 5A in the second example embodiment. The basic configuration of the second example embodiment is the same as that of the first example embodiment. Thus, different points are mainly described below.

The spacer 4A includes a protrusion 44A that is located on the core portion 41 to limit movement of a material of the insulating resin layer 5A. The protrusion 44A is located on the spacer second main surface D2 of the core portion 41.

Specifically, the protrusion 44A protrudes in the lamination direction T on the spacer second main surface D2 of the core portion 41, and has a predetermined length in the width direction W. Both ends of the protrusion 44A in the width direction W are close to both ends of the spacer second main surface D2 in the width direction W. Both ends of the protrusion 44A in the width direction W may extend to both ends of the spacer second main surface D2 in the width direction W.

More specifically, the protrusion 44A includes a first main surface 44Aa facing toward the other spacer 4A in the length direction L, a side surface 44Ab facing toward the side opposite to the multilayer body 2 in the lamination direction T, and a second main surface 44Ac facing toward the side opposite to the other spacer 4A in the length direction L.

As depicted in FIG. 8, the spacer 4A includes a low-melting-point surface layer 42A. The low-melting-point surface layer 42A includes, for example, Sn. It is preferable that the low-melting-point surface layer 42A have favorable wettability with the solder H (conductive adhesive) used in mounting and for connecting the spacer 4A and the outer electrode 3. With the low-melting-point surface layer 42A, favorable solderability is achieved at the spacer 4A when the multilayer ceramic capacitor 1 is mounted on a substrate.

The low-melting-point surface layer 42A entirely coats the core portion 41. Specifically, the low-melting-point surface layer 42A is provided on the spacer main surfaces D, the spacer side surfaces F, and the spacer end surfaces E of the core portion 41.

The low-melting-point surface layer 42A covers the entire surface of the protrusion 44A. As a modification, it is also possible that the low-melting-point surface layer 42A does not cover part of the protrusion 44A or does not cover the protrusion 44A at all.

The insulating resin layer 5A is connected to the multilayer body second main surface A2 of the multilayer body 2 and the protrusion 44A. The insulating resin layer 5A is also connected to the solder H (conductive adhesive). Specifically, the insulating resin layer 5A includes a main layer 51A located on the multilayer body second main surface A2 and connection portions 52A at both ends of the main layer 51A, and the connection portions 52A are each connected to the protrusion 44A and the solder H (conductive adhesive). The connection portions 52A each extend along the spacer first end surface E1 of the spacer 4A to reach the spacer second main surface D2. The connection portions 52A are upward-spread portions extending from the main layer 51A.

Specifically, the connection portion 52A of the insulating resin layer 5A is connected to the spacer first end surface E1 of the core portion 41, a portion of the spacer second main surface D2 of the core portion 41 on the other spacer 4A side, and the first main surface 44Aa of the protrusion 44A. As a modification, the connection portion 52A may be connected to the side surface 44Ab in addition to the first main surface 44Aa. As another modification, the connection portion 52A may be connected to the second main surface 44Ac in addition to the first main surface 44Aa and the side surface 44Ab. As still another modification, the connection portion 52A may be connected to a portion of the spacer second main surface D2 on the side opposite to the other spacer 4A.

As described above, in the present example embodiment, the protrusion 44A is provided on the spacer second main surface D2 of the spacer 4A, and the insulating resin layer 5A and the protrusion 44A are directly connected to each other. That is, excessive wraparound of the material of the insulating resin layer 5A can be prevented or reduced by the protrusion 44A. It is possible to reduce a possibility that the material of the insulating resin layer 5A excessively extends around to the spacer second end surface E2 and thus solder (conductive adhesive) used in mounting does not sufficiently adhere to the spacer 4A.

More specifically, the protrusion 44A is directly connected only to a portion of a first region D21 on the spacer first end surface E1 side, of regions obtained by bisecting the spacer second main surface D2 in the length direction L. That is, the protrusion 44A is not directly connected in a second region D22 on the side opposite to the spacer first end surface E1, of the regions obtained by bisecting the spacer second main surface D2 in the length direction L. Thus, it is possible to properly limit the amount of movement of the material of the insulating resin layer 5A.

The surface roughness of the protrusion 44A is rougher than that of the core portion 41. As a result, due to an anchor effect, the adhesion strength between the insulating resin layer 5A and the protrusion 44A can be increased. Roughening treatment for the protrusion 44A may be performed by chemical etching or the like, or by applying a physical impact. The surface roughness of the side surface 44Ab of the protrusion 44A may be rougher than the surface roughness of the first main surface 44Aa of the protrusion 44A, and may be rougher than the surface roughness of the second main surface 44Ac of the protrusion 44A.

In the first example embodiment, the protrusion 44 is formed on the spacer first end surface E1, which is the inner surface of the spacer 4. However, the position of the protrusion 44 is not limited to the spacer first end surface E1 of the spacer 4.

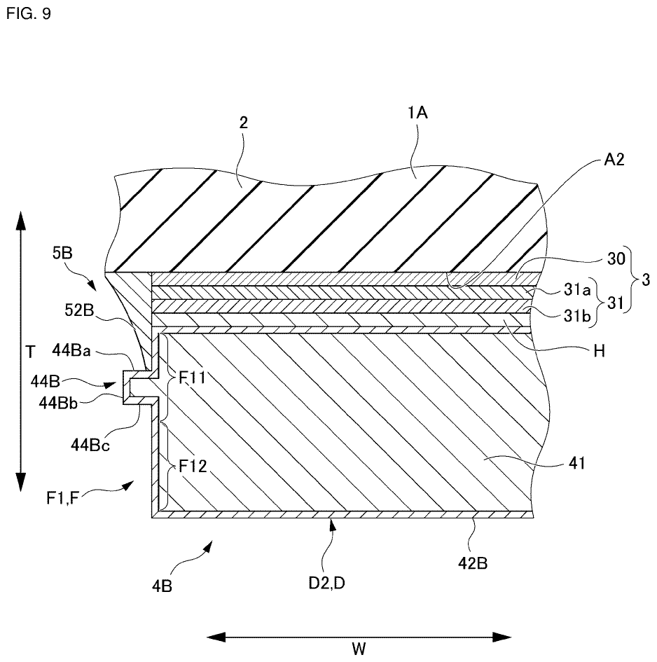

With reference to FIG. 9, a third example embodiment is described as an example in which the position of the protrusion 44 is different from that of the first example embodiment. FIG. 9 is a cross-sectional view depicting a connection state of a spacer 4B and an insulating resin layer 5B in the third example embodiment. The basic configuration of the third example embodiment is the same as that of the first example embodiment. Thus, different points are mainly described below.

The spacer 4B includes a protrusion 44B provided on the core portion 41 to limit movement of a material of the insulating resin layer 5B. The protrusion 44B is located on the spacer first side surface F1 of the core portion 41.

Specifically, the protrusion 44B protrudes in the width direction W on the spacer first side surface F1 of the core portion 41, and has a predetermined length in the length direction L. Both ends of the protrusion 44B in the length direction L are close to both ends of the spacer first side surface F1 in the length direction L. Both ends of the protrusion 44B in the length direction L may extend to both ends of the spacer first side surface F1 in the length direction L.

More specifically, the protrusion 44B includes a first main surface 44Ba facing toward the multilayer body 2 in the lamination direction T, a side surface 44Bb facing outward in the width direction W, and a second main surface 44Bc facing toward the side opposite to the multilayer body 2 in the lamination direction T.

As depicted in FIG. 9, the spacer 4B includes a low-melting-point surface layer 42B. The low-melting-point surface layer 42B includes, for example, Sn. It is preferable that the low-melting-point surface layer 42B have favorable wettability with the solder H (conductive adhesive) used in mounting and to connect the spacer 4B and the outer electrode 3. With the low-melting-point surface layer 42B, favorable solderability is achieved at the spacer 4B when the multilayer ceramic capacitor is mounted on a substrate.

The low-melting-point surface layer 42B entirely coats the core portion 41. Specifically, the low-melting-point surface layer 42B is located on the spacer main surfaces D, the spacer side surfaces F, and the spacer end surfaces E of the core portion 41.

The low-melting-point surface layer 42B covers the entire surface of the protrusion 44B. As a modification, it is also possible that the low-melting-point surface layer 42B does not cover a portion of the protrusion 44B or does not cover the protrusion 44B at all.

The insulating resin layer 5B is connected to the multilayer body second main surface A2 of the multilayer body 2 and the protrusion 44B. The insulating resin layer 5B is also connected to the solder H. Specifically, the insulating resin layer 5B includes a main layer (not depicted) formed on the multilayer body second main surface A2 and connection portions 52B formed at both ends of the main layer, and the connection portions 52B are each connected to the protrusion 44B and the solder H. The connection portions 52B are upward-spread portions extending from the main layer.

Specifically, the connection portion 52B of the insulating resin layer 5B is connected to a portion of the spacer first side surface F1 of the core portion 41 on the multilayer body 2 side and the first main surface 44Ba of the protrusion 44B. As a modification, the connection portion 52B may be connected to the side surface 44Bb of the protrusion 44B. As another modification, the connection portion 52B may be connected to the second main surface 44Bc. As still another modification, the connection portion 52B may be connected also to a portion of the spacer first side surface F1 of the core portion 41 on the side opposite to the multilayer body 2 across the protrusion 44B.

As described above, in the present example embodiment, the protrusion 44B is provided on the spacer first side surface F1 of the spacer 4B, and the insulating resin layer 5B and the protrusion 44B are directly connected to each other. That is, excessive wraparound of the material of the insulating resin layer 5B can be prevented or reduced by the protrusion 44B. Thus, it is possible to prevent or reduce the occurrence of a situation in which the material of the insulating resin layer 5B moves from the multilayer body second main surface A2 toward the spacer second main surface D2 of the spacer 4B and reaches the spacer second main surface D2. As a result, the adhesion area between solder in mounting and the spacer 4B can be sufficiently secured, thereby achieving the multilayer ceramic capacitor excellent in durability when mounted.

More specifically, the protrusion 44B is located on a portion of a first region F11 on the multilayer body 2 side, of regions obtained by bisecting the spacer first side surface F1 in the lamination direction T of the spacer 4B. That is, the protrusion 44B is not provided in a second region F12 on the side opposite to the multilayer body 2, of the regions obtained by bisecting the spacer first side surface F1 in the lamination direction T of the spacer 4B. Thus, it is possible to properly limit the amount of movement of the material of the insulating resin layer 5B.

The surface roughness of the protrusion 44B is rougher than that of the core portion 41. As a result, due to an anchor effect, the adhesion strength between the insulating resin layer 5B and the protrusion 44B can be increased. Roughening treatment for the protrusion 44B may be performed by chemical etching or the like, or by applying a physical impact. The surface roughness of the side surface 44Bb of the protrusion 44B may be rougher than the surface roughness of the first main surface 44Ba of the protrusion 44B, and may be rougher than the surface roughness of the second main surface 44Bc of the protrusion 44B.

As a modification of the third example embodiment, the protrusion may be provided on the spacer second side surface F2 of the spacer 4B. That is, the protrusion may be provided only on the spacer first side surface F1 of the spacer 4B, or may be provided only on the spacer second side surface F2. Alternatively, the protrusion may be provided on both the spacer first side surface F1 and the spacer second side surface F2.

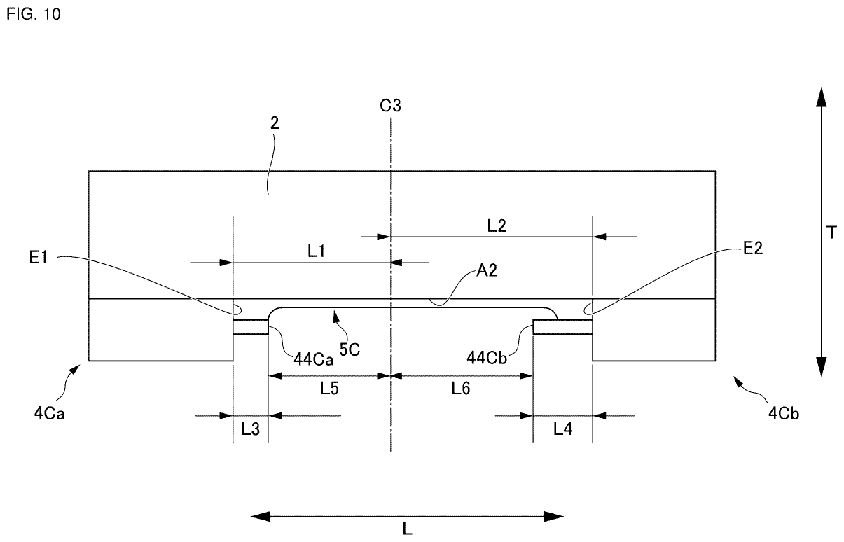

In the first example embodiment, the distances between the spacer first end surfaces E1 of the pair of spacers 4 and the center of the multilayer body 2 in the length direction L are the same. Further, the projection lengths of the protrusions 44 in the length direction L are the same or substantially the same. With reference to FIG. 10, an example different from the above structure is described as a modification of the first example embodiment. FIG. 10 is a schematic diagram depicting a positional relationship and a dimensional relationship among the multilayer body second main surface A2 of the multilayer body 2, a first spacer 4Ca and a second spacer 4Cb, and a first protrusion 44Ca and a second protrusion 44Cb in the modification.

In the length direction L, a distance L1 between the spacer first end surface E1 (inner surface) of the first spacer 4Ca of a pair of spacers 4C and a center C3 of the multilayer body second main surface A2 is shorter than a distance L2 between the spacer first end surface E1 (inner surface) of the second spacer 4Cb and the center C3 of the multilayer body second main surface A2.

In the length direction L, a length L3 of the first protrusion 44Ca on the first spacer 4Ca is shorter than a length L4 of the second protrusion 44Cb on the second spacer 4Cb.

In the present example embodiment, because the first protrusion 44Ca is shorter than the second protrusion 44Cb in the length direction L, a distance L5 from the tip of the first protrusion 44Ca to the center C3 can be made close to a distance L6 from the tip of the second protrusion 44Cb to the center C3.

Although the plurality of example embodiments of the present invention have been described above, the present invention is not limited to the above example embodiments, and various modifications can be made without departing from the gist of the invention. In particular, the example embodiments and the modifications described in the present specification can be combined in any manner as required.

The shape, position, and number of the protrusions 44 are not particularly limited. The protrusion 44 may have a curved shape or a wave shape in front view.

The protrusion 44 may include a plurality of projections. The total length of the plurality of projections may be about 90% or more of a length of a surface on which the projections are located. Further, an interval between the projections may be less than or equal to about one half of the length of one projection.

The protrusion 44 may be free of a corner portion in cross section, that is, may have gently curved connection surfaces between the respective surfaces. The side surface of the protrusion 44 may have a concave shape or a convex shape.

The protrusion 44 may be a structure separate from the core portion 41, and be attached to the core portion.

The low-melting-point surface layer 42 is not required to be provided on a protrusion connection surface to which the insulating resin layer 5 is connected in the protrusion 44. The low-melting-point surface layer 42 may be absent only from the side surface 44b of the protrusion 44. The absence of the low-melting-point surface layer 42 on the protrusion connection surface makes it possible to reduce or prevent a decrease in an adhesion force caused by melting of the low-melting-point surface layer 42 during reflow of the solder H (conductive adhesive) used in mounting and in joining the outer electrode 3 and the spacer 4.

A high-melting-point surface layer having a melting point higher than that of the low-melting-point surface layer 42 may be provided on the protrusion connection surface.

The first main surface 44a of the protrusion 44 may be coated with the solder H (conductive adhesive) used for connecting the outer electrode 3 and the spacer 4, and the insulating resin layer 5 may be provided thereon. The first main surface 44a of the protrusion 44 and the side surface 44b of the protrusion 44 may be coated with the solder H (conductive adhesive) used for connecting the outer electrode 3 and the spacer 4, and the insulating resin layer 5 may be provided thereon. The first main surface 44a of the protrusion 44, the second main surface 44c of the protrusion 44, and the side surface 44b of the protrusion 44 may be coated with the solder H (conductive adhesive) used to connect the outer electrode 3 and the spacer 4, and the insulating resin layer 5 may be provided thereon.

As still another example embodiment, similarly to the third example embodiment, the protrusion may protrude in the width direction W on the spacer first side surface F1 of the core portion. A difference from the third example embodiment is that both ends of the protrusion in the lamination direction T are close to both ends of the spacer first side surface F1 in the lamination direction T. Both ends of the protrusion in the lamination direction T may extend to both ends of the spacer first side surface F1 in the lamination direction. This makes it possible to reduce or prevent excessive wraparound of the material of the insulating resin layer 5 toward the spacer second end surface E2, and to improve the adhesion force between solder used in mounting and the spacer.

The outer electrode may include a combination of Ni with an additive material and Cu/Ni/Sn plating.

The outer electrode may include a combination of Ni with an additive material, Cu with a glass component, and Ni/Sn plating.

The outer electrode may include a combination of Cu with a glass component, a resin electrode, and Ni/Sn plating.

The shape of the spacer 4 is not particularly limited, and the spacer 4 may have a shape in which an outer side portion in the length direction is cut away. This makes it possible to prevent excessive upward spreading of solder to the multilayer ceramic capacitor. Further, a concave portion may be extend the spacer second main surface D2 toward the spacer first main surface D1. It is preferable that the low-melting-point surface layer 42 be provided on a circumferential surface of the concave portion formed in the spacer 4. This can reduce or prevent excessive solder upward spreading, to the capacitor body 1A, of solder used in mounting. At this time, the insulating resin layer 5 may extend around so as to cover a portion of the concave portion or the concave portion. In this case, because a cavity is provided in the spacer 4, vibration can be damped by the cavity portion.

Further, a concave portion may extend from the spacer first main surface D1 toward the spacer second main surface D2. It is preferable that the low-melting-point surface layer 42 be provided on a circumferential surface of the concave portion formed in the spacer 4. This can reduce or prevent excessive solder upward spreading, to the capacitor body 1A, of solder used in connecting the spacer 4 and the capacitor body 1A. Further, the configuration is not limited thereto, and only the low-melting-point surface layer 42 may be provided on the concave portion.

Further, the spacer 4 may have a shape in which a hole extends from the spacer first main surface D1 to the spacer second main surface D2. It is preferable that the low-melting-point surface layer 42 be provided on a circumferential surface of the hole in the spacer 4. This can reduce or prevent excessive solder upward spreading, to the capacitor body 1A, of solder used in mounting or in connecting the spacer 4 and the capacitor body 1A. At this time, the insulating resin layer 5 may extend around so as to cover a portion of the hole or the hole. A gap may be present between the solder H entering the hole from the spacer first main surface D1 and the insulating resin layer 5 extending around from the spacer second main surface D2. In this case, because a cavity is provided in the spacer 4, vibration can be damped by the cavity portion.

The size of the spacer 4 in a view along the lamination direction T is not particularly limited. The spacer 4 may be smaller than the area of the outer electrode 3 connected through solder, and may be separated from an end portion of the outer electrode 3 on the outer side in the length direction L. This can prevent excessive upward spreading of the solder to the capacitor body 1A.

Further, when the outer electrode 3 is bisected in the length direction L, the spacer 4 may be located near the outer electrode 3 on the inner side in the length direction L. This can prevent excessive upward spreading of the solder to the capacitor body 1A.

The shape of the insulating resin layer 5 in plan view is not limited to a rectangular shape. The edges of the insulating resin layer extending in the length direction L may be linear. Alternatively, the edges may have a curved shape convex outward in the width direction W, or have a curved shape concave inward in the width direction W.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor body including a multilayer body including a main surface and a pair of outer electrodes provided separately from each other in a first direction;
a pair of spacers each connected to a respective one of the pair of outer electrodes; and
a coating material on the main surface; wherein
each of the pair of spacers includes a main portion and a protrusion on the main portion; and
the coating material is directly connected to the main surface of the multilayer body and the protrusion.

2. The multilayer ceramic electronic component according to claim 1, further comprising:
a conductive adhesive that connects each of the pair of outer electrodes to a respective one of the pair of spacers.

3. The multilayer ceramic electronic component according to claim 2, wherein the coating material is connected to the multilayer body, the conductive adhesive, and the protrusion.

4. The multilayer ceramic electronic component according to claim 1, wherein the protrusions are on inner surfaces opposed to each other in the pair of spacers.

5. The multilayer ceramic electronic component according to claim 4, wherein
the pair of spacers are provided separately from each other in the first direction;
in the first direction, a distance between the inner surface of a first spacer of the pair of spacers and a center of the main surface is shorter than a distance between the inner surface of a second spacer and the center of the main surface; and
in the first direction, a length of a first protrusion on the first spacer is shorter than a length of a second protrusion on the second spacer.

6. The multilayer ceramic electronic component according to claim 1, wherein
the spacer includes a first main surface and a second main surface facing each other in a height direction in which the capacitor body and the spacer are arranged, a first side surface and a second side surface facing each other in a second direction orthogonal to the first direction in which the pair of spacers are arranged and the height direction, and an inner surface on a side where the pair of spacers are opposed to each other;
the first main surface is located on a capacitor body side; and
the protrusion is on a first side surface.

7. The multilayer ceramic electronic component according to claim 6, wherein the protrusion is in a region on the inner surface side, of regions obtained by bisecting the first side surface in the first direction.

8. The multilayer ceramic electronic component according to claim 1, wherein
the spacer includes a first main surface and a second main surface facing each other in a height direction in which the capacitor body and the spacer are arranged, a first side surface and a second side surface facing each other in a second direction orthogonal to the first direction in which the pair of spacers are arranged and the height direction, and an inner surface on a side where the pair of spacers are opposed to each other;
the first main surface is located on the capacitor body side; and
the protrusion is on a second main surface.

9. The multilayer ceramic electronic component according to claim 8, wherein the protrusion is in a region on an inner surface side, of regions obtained by bisecting the second main surface in the first direction.

10. The multilayer ceramic electronic component according to claim 1, wherein a surface roughness of the protrusion is rougher than a surface roughness of the spacer.

11. The multilayer ceramic electronic component according to claim 3, wherein the protrusions are on inner surfaces opposed to each other in the pair of spacers.

12. The multilayer ceramic electronic component according to claim 3, wherein
the spacer includes a first main surface and a second main surface facing each other in a height direction in which the capacitor body and the spacer are arranged, a first side surface and a second side surface facing each other in a second direction orthogonal to the first direction in which the pair of spacers are arranged and the height direction, and an inner surface on a side where the pair of spacers are opposed to each other;
the first main surface is located on a capacitor body side; and
the protrusion is on a first side surface.

13. The multilayer ceramic electronic component according to claim 3, wherein
the spacer includes a first main surface and a second main surface facing each other in a height direction in which the capacitor body and the spacer are arranged, a first side surface and a second side surface facing each other in a second direction orthogonal to the first direction in which the pair of spacers are arranged and the height direction, and an inner surface on a side where the pair of spacers are opposed to each other;
the first main surface is located on the capacitor body side; and
the protrusion is on a second main surface.

14. The multilayer ceramic electronic component according to claim 10, wherein the protrusions are on inner surfaces opposed to each other in the pair of spacers.

15. The multilayer ceramic electronic component according to claim 10, wherein
the spacer includes a first main surface and a second main surface facing each other in a height direction in which the capacitor body and the spacer are arranged, a first side surface and a second side surface facing each other in a second direction orthogonal to the first direction in which the pair of spacers are arranged and the height direction, and an inner surface on a side where the pair of spacers are opposed to each other;
the first main surface is located on a capacitor body side; and
the protrusion is on a first side surface.

16. The multilayer ceramic electronic component according to claim 10, wherein
the spacer includes a first main surface and a second main surface facing each other in a height direction in which the capacitor body and the spacer are arranged, a first side surface and a second side surface facing each other in a second direction orthogonal to the first direction in which the pair of spacers are arranged and the height direction, and an inner surface on a side where the pair of spacers are opposed to each other;
the first main surface is located on the capacitor body side; and
the protrusion is on a second main surface.

17. The multilayer ceramic electronic component according to claim 4, wherein both ends of the protrusion in the second direction are close to both ends of the spacer in the second direction.

18. The multilayer ceramic electronic component according to claim 6, wherein both ends of the protrusion in the first direction are close to both ends of the spacer in the first direction.

19. The multilayer ceramic electronic component according to claim 6, wherein both ends of the protrusion in the height direction are close to both ends of the spacer in the height direction.

20. The multilayer ceramic electronic component according to claim 8, wherein both ends of the protrusion in the second direction are close to both ends of the spacer in the second direction.
